(19) United States
(12) Patent Application Publication
(10) Pub. No.: US 2025/0117188 A1
(43) Pub. Date: Apr. 10, 2025

(54) Methods and Systems that Generate Random Numbers Based on Nondeterministic Phenomena that are Computationally Initiated and Computationally Accessed Within a Computer System

(71) Applicant: VMware LLC, Palo Alto, CA (US)

(72) Inventors: Avishay YANAI, Herzliya (IL); Alex MARKUZE, Rosh HaAyin (IL); John MANFERDELLI, San Francisco, CA (US); Igor GOLIKOV, Herzliya (IL); lttai ABRAHAM, Herzliya (IL); Benny PINKAS, Herzliya (IL)

(21) Appl. No.: 18/422,442

(22) Filed: Jan. 25, 2024

Related U.S. Application Data
(60) Provisional application No. 63/441,368, filed on Jan. 26, 2023.

(51) Int. Cl. G06F 7/58

(52) U.S. Cl. CPC G06F 7/58

(57) ABSTRACT

The current document is directed to methods and systems that generate sequences of random numbers. Unlike many currently available random-number generators that continuously measures a physical apparatus or other signal source, the currently disclosed methods and systems employ nondeterministic phenomena that are computationally initiated and computationally accessed within a computer system. The nondeterministic phenomena are often a produced by multiple simultaneously executing, asynchronous threads or other computational entities, with the unpredictability arising from multiple different types and sources of nondeterministic behavior within the computer system. Unlike pseudorandom-number generators, statistics and metrics computed from sequences of random numbers produced by the currently disclosed random-number generators have values close to those expected for a random-selection process. Unlike random numbers that depend on specialized circuitry or single signal sources, the currently disclosed random-number generators used standard components and significant redundancy and robustness to single-point failures.

### CROSS REFERENCE TO RELATED APPLICATIONS

1) This application claims priority to U.S. Patent Application No. 63/441,368, filed Jan. 26, 2023, titled “METHODS AND SYSTEMS THAT GENERATE RANDOM NUMBERS BASED ON NONDETERMINISTIC PHENOMENA THAT ARE COMPUTATIONALLY INITIATED AND COMPUTATIONALLY ACCESSED WITHIN ACOMPUTER SYSTEM,” the entire teachings of which are hereby incorporated by reference in its entirety for all purposes.

### TECHNICAL FIELD

2) The current document is directed to generation of sequences of random numbers and, in particular, to methods and systems that computationally generate sequences of random numbers based on underlying nondeterministic phenomena in computer systems.

### BACKGROUND

3) Random numbers are used in many different ways in modern computer systems and computer-implemented methods and processes. Generation of sequences of random numbers are often needed for accurate computational simulations and modeling and lie at the foundation of data encryption used to secure communications, data storage, financial transactions, and many other types of information exchanges. Various different approaches to obtaining sequences of random numbers or pseudorandom numbers are currently used. In general, sequences of random numbers are obtained by observing unpredictable signal sources, such as circuits that produce observable electronic noise and radio-frequency noise, background cosmic radiation, and other unpredictable signal sources. In fact, many modern processors provide specialized circuitry that produce unpredictable signals based on instabilities in electronic circuits, reception of radio-frequency noise, and other such physical phenomena. By contrast, a variety of different algorithmic methods are used to computationally generate sequences of pseudorandom numbers, and libraries of routines that are commonly available to programmers often include one or more pseudorandom-number generators.

4) While there are various different common understandings of the concept of a random number and a random-number generator, technical definitions are often circular and seemingly incomplete. Many different types of tests, statistics, and metrics are used to characterize the degree of randomness or unpredictability of the output of a random-number generator or pseudorandom-number generator. However, such tests, statistics, and metrics generally do not provide a precise or definitive estimation of a quantitative degree of randomness. It is well-known that commonly used pseudorandom number generators do not, in fact, produce sequences of random numbers corresponding to an ideal output of a random-selection process and that sequences of random numbers produced by random-number generators based on observations of physical phenomena and signal sources may also fail to produce sequences of random numbers corresponding to the output of a random-selection process due to various unfounded assumptions and failures. What might appear to be a random sequence of observed values, on first impression, may turn out to contain repeated patterns, periodicities, and time dependencies. Many of the algorithmic pseudorandom-number generators are, in fact, deterministic. It may be very difficult to detect the fact that the output of a random-number generator is not, in fact, representative of a random-selection process. Furthermore, specialized device-based or circuit-based random-number generators, as opposed to pseudorandom-number generators, may not be available or accessible in many computational environments, including virtualized systems and generic processor-controlled devices and systems. For all of these reasons, those involved in designing, manufacturing, and using random-number generators, pseudorandom-number generators, and the many different types of systems and services that depend on access to random numbers continue to seek improved random-number-generation methods and systems.

### SUMMARY

5) The current document is directed to methods and systems that generate sequences of random numbers. Unlike many currently available random-number generators that continuously measures a physical apparatus or other signal source, the currently disclosed methods and systems employ nondeterministic phenomena that are computationally initiated and computationally accessed within a computer system. The nondeterministic phenomena are often a produced by multiple simultaneously executing, asynchronous threads or other computational entities, with the unpredictability arising from multiple different types and sources of nondeterministic behavior within the computer system. Unlike pseudorandom-number generators, statistics and metrics computed from sequences of random numbers produced by the currently disclosed random-number generators have values close to those expected for a random-selection process. Unlike random numbers that depend on specialized circuitry or single signal sources, the currently disclosed random-number generators use standard components and significant redundancy and robustness to single-point failures.

### BRIEF DESCRIPTION OF THE DRAWINGS

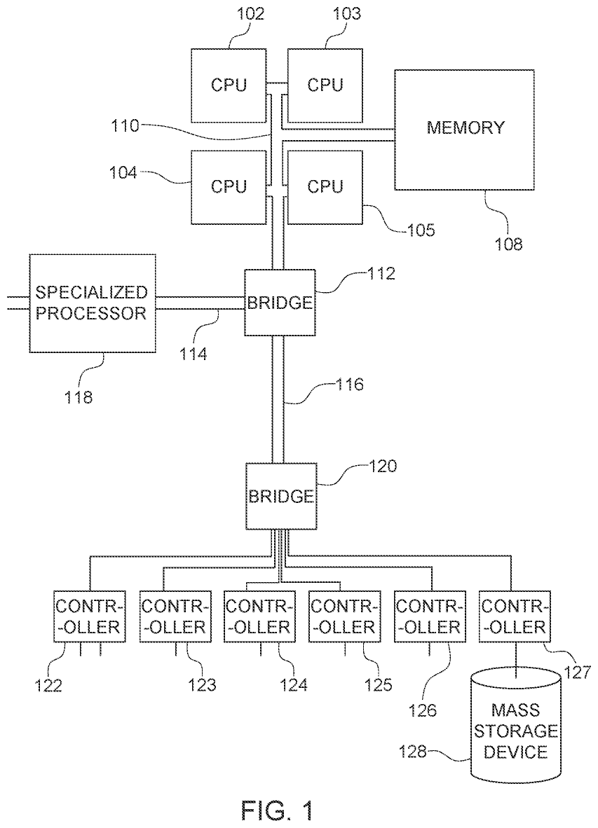

6) FIG. 1 provides a general architectural diagram for various types of computers.

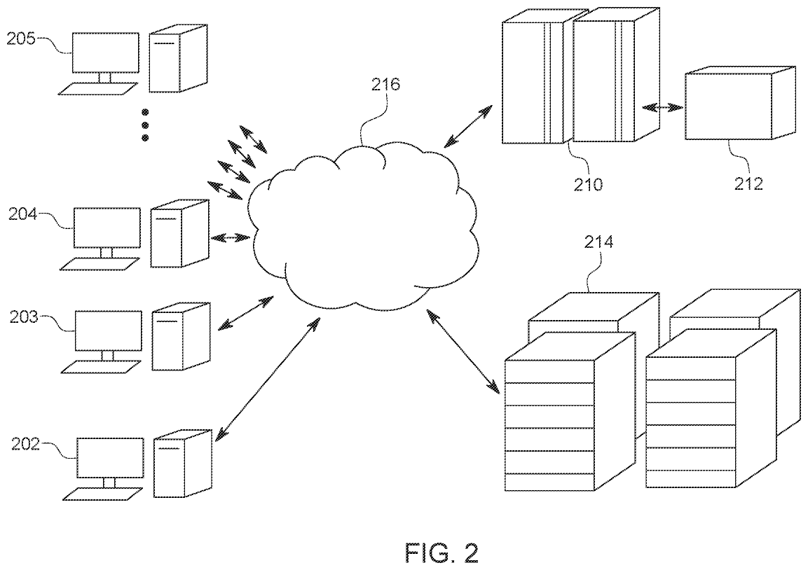

7) FIG. 2 illustrates an Internet-connected distributed computer system.

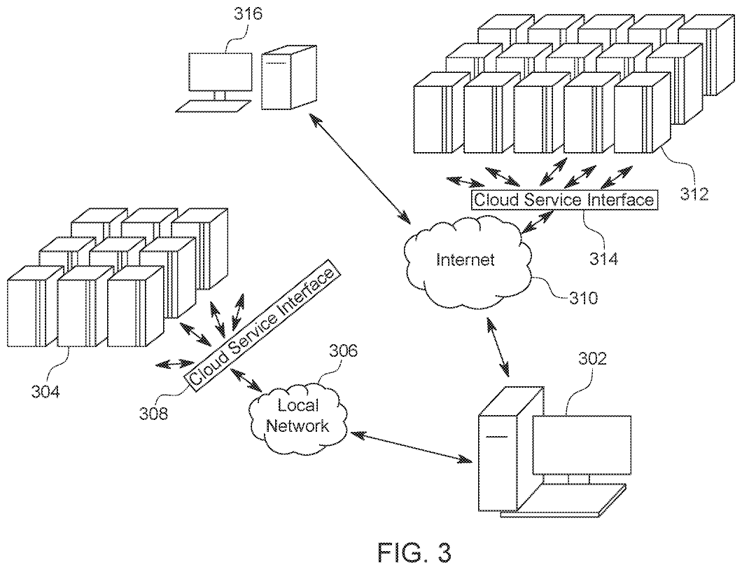

8) FIG. 3 illustrates cloud computing.

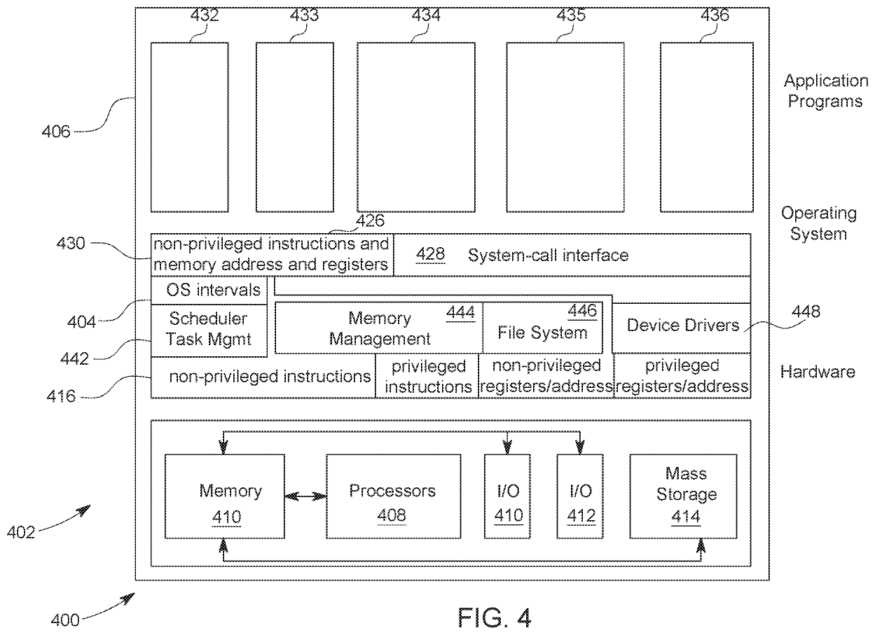

9) FIG. 4 illustrates generalized hardware and software components of a general-purpose computer system, such as a general-purpose computer system having an architecture similar to that shown in FIG. 1.

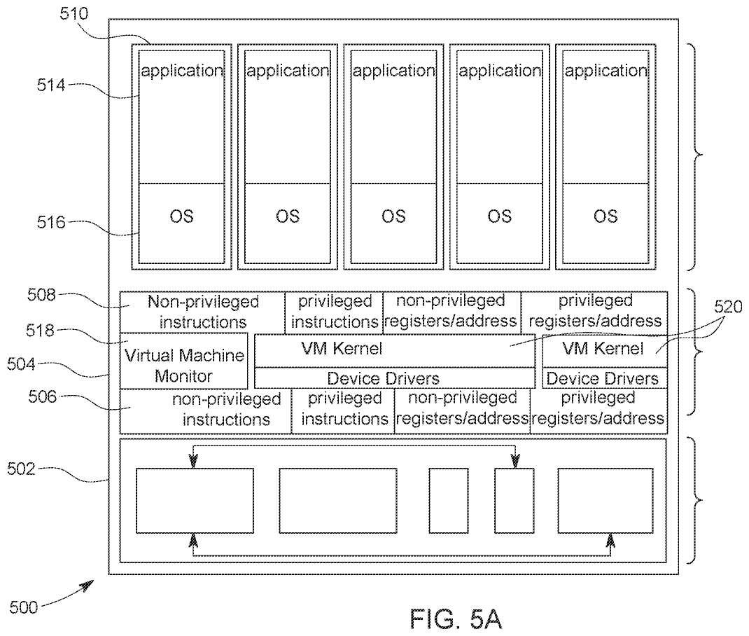

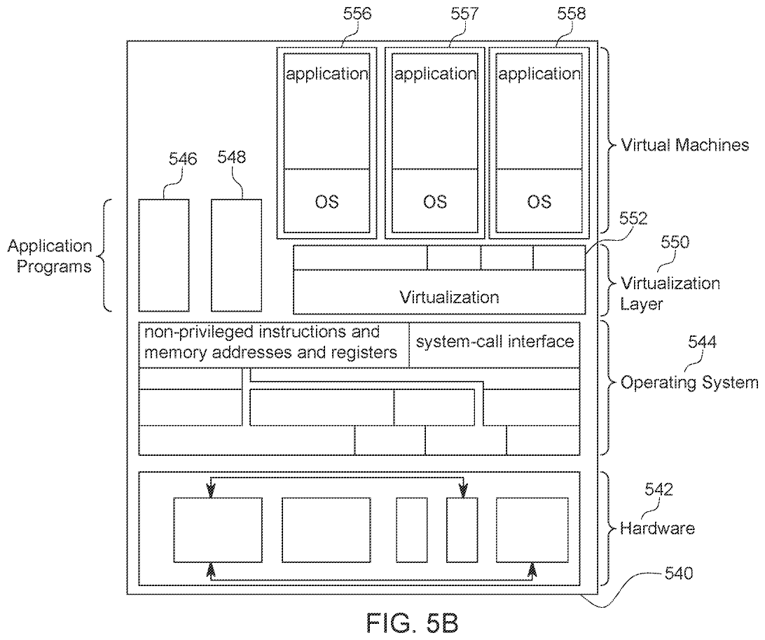

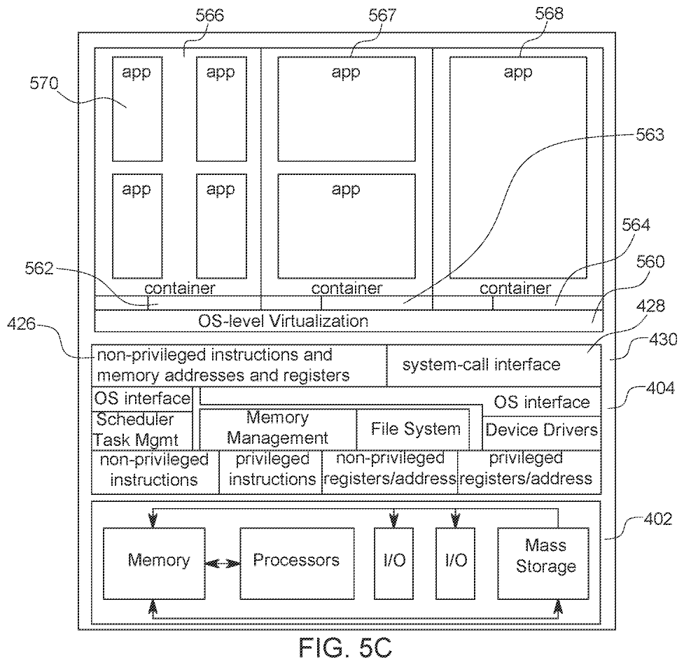

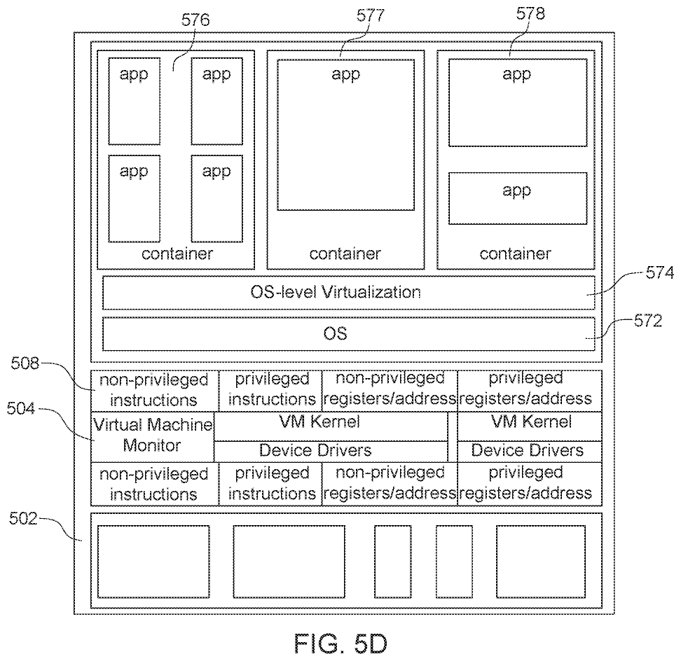

10) FIGS. 5A-D illustrate two types of virtual machine and virtual-machine execution environments.

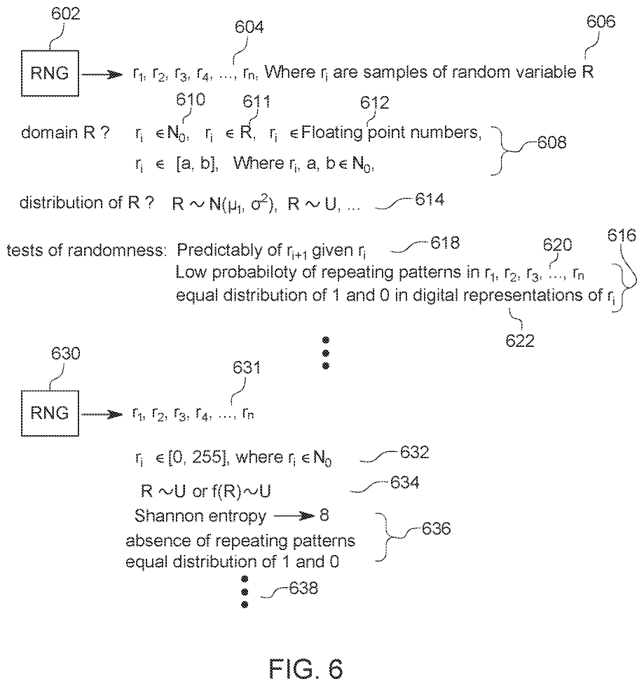

11) FIG. 6 illustrates the general problem domain addressed by the currently disclosed methods and systems.

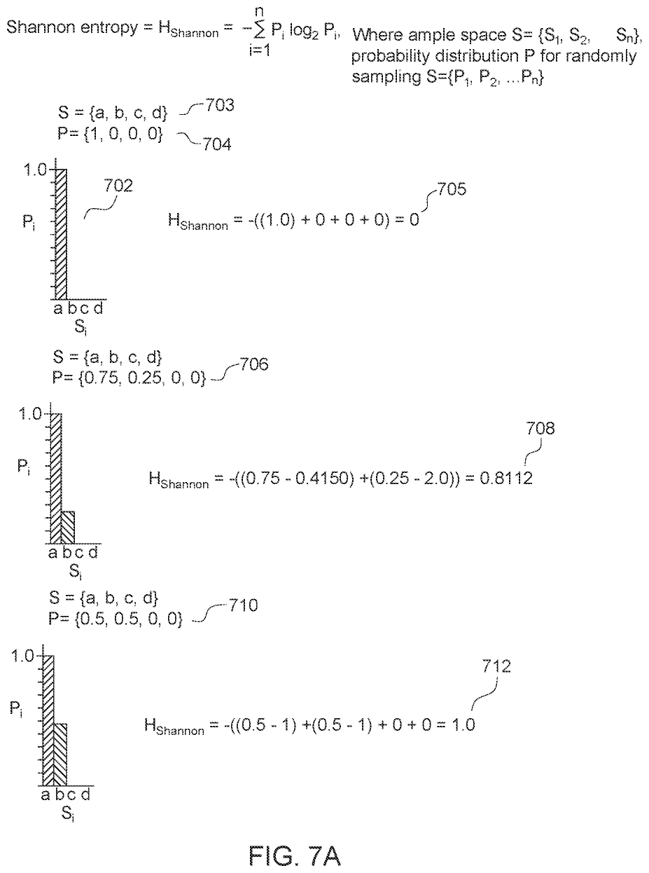

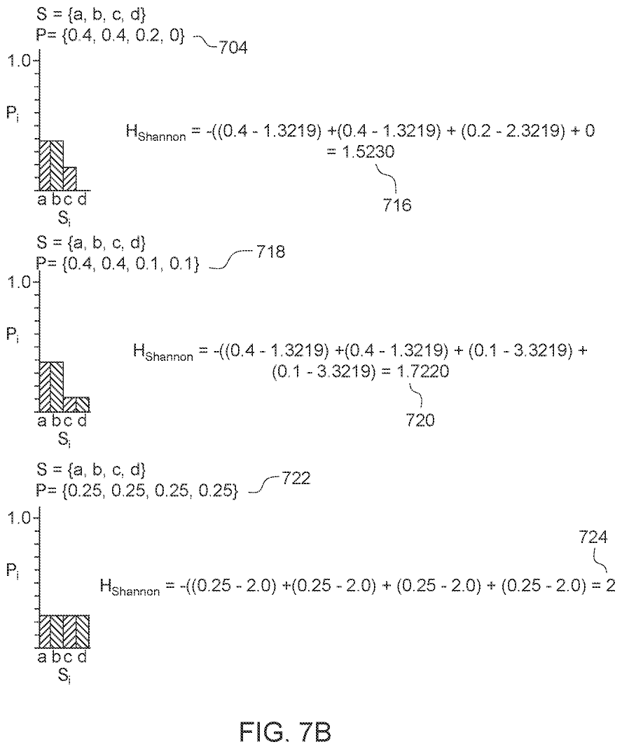

12) FIGS. 7A-B illustrate Shannon entropy.

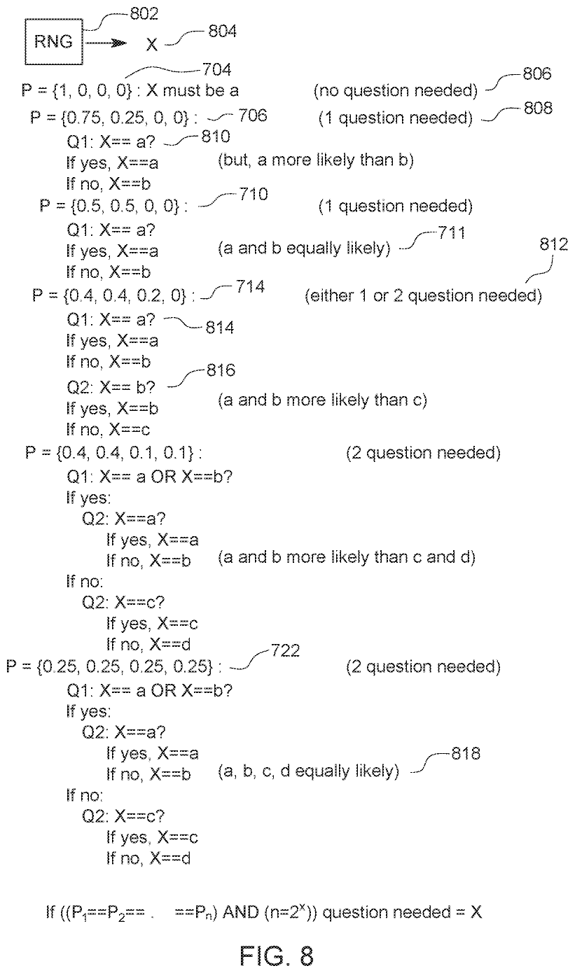

13) FIG. 8 illustrates how the Shannon entropy is related to the number of questions, on average, needed to determine which value of a set of sample values has been generated by a random-number generator associated with the Shannon entropy.

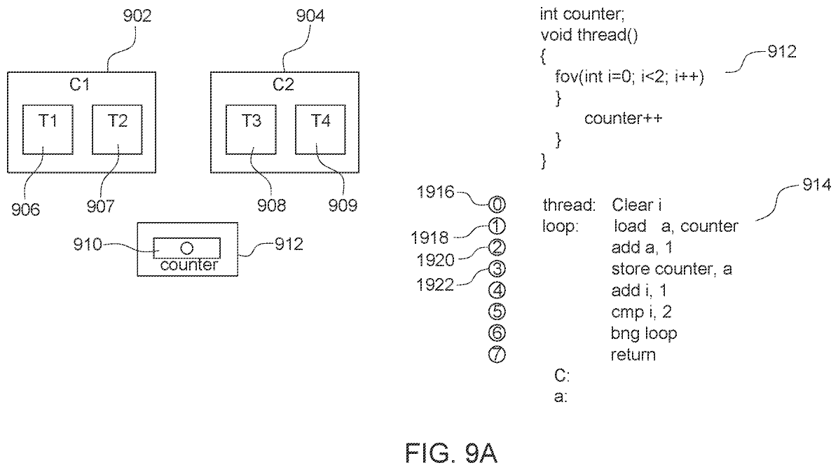

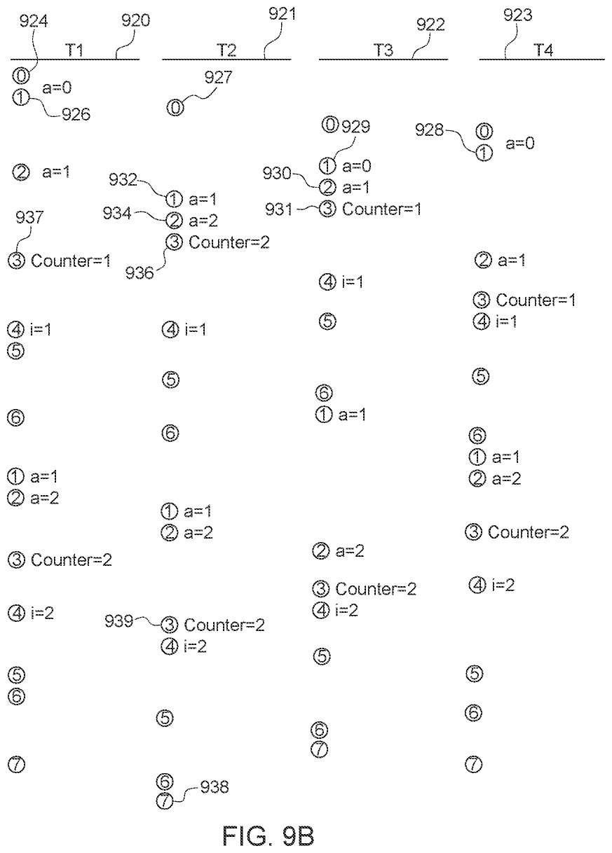

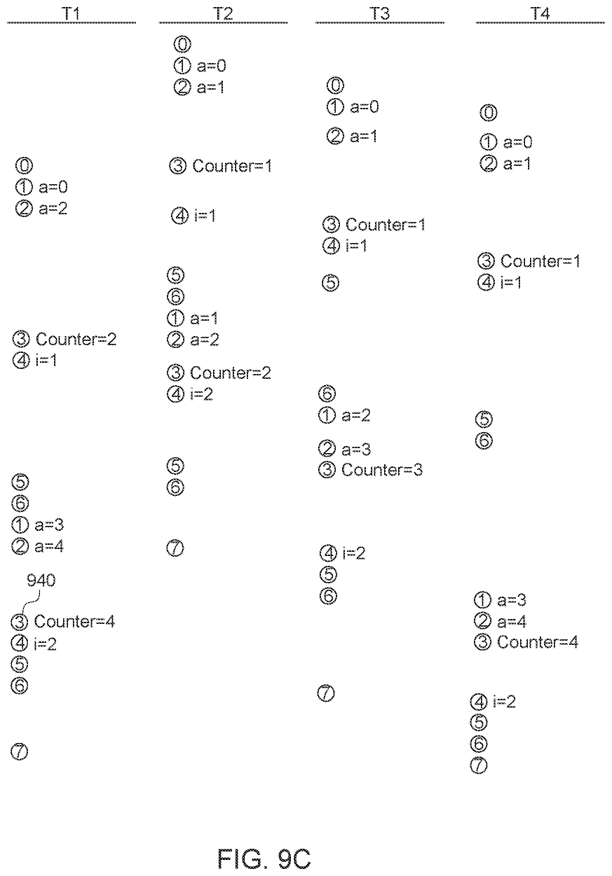

14) FIGS. 9A-C illustrates the concept underlying a first implementation of the currently disclosed random-number-generation methods and systems.

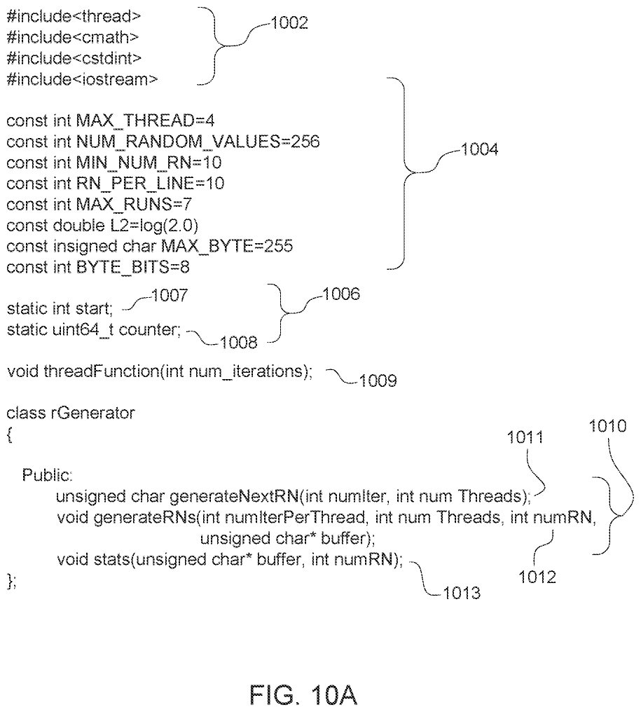

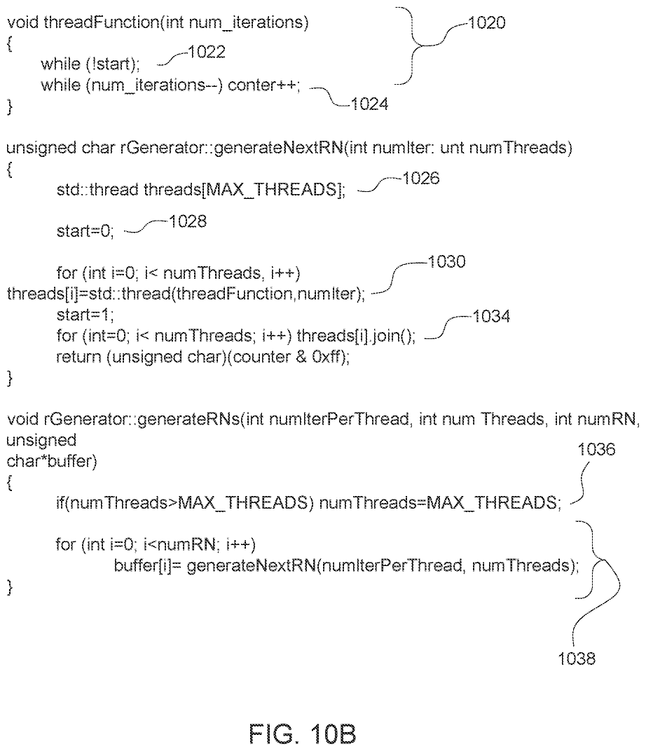

15) FIGS. 10A-B provide a first implementation of the currently disclosed methods and systems, introduced above with reference to FIGS. 9A-C.

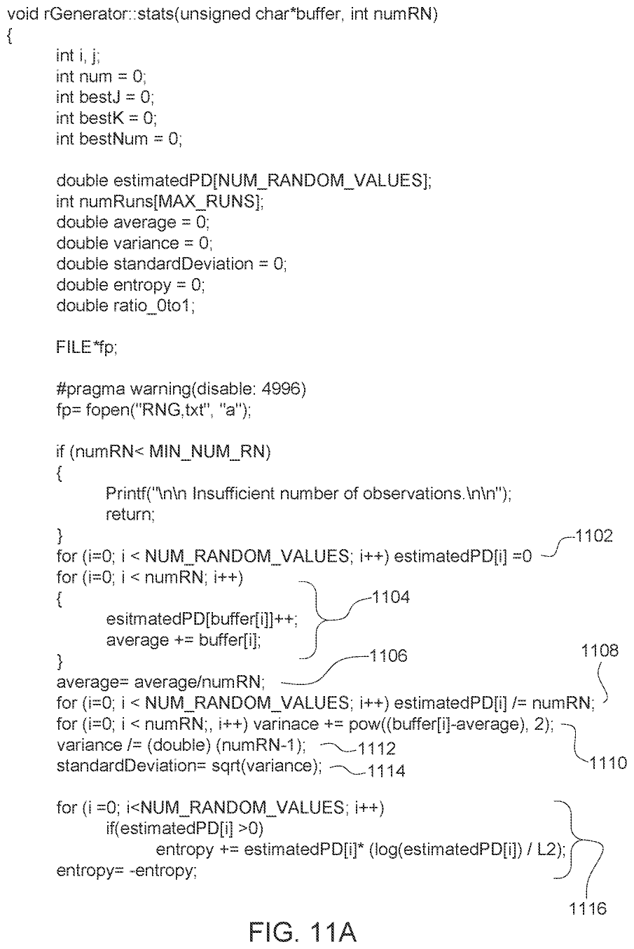

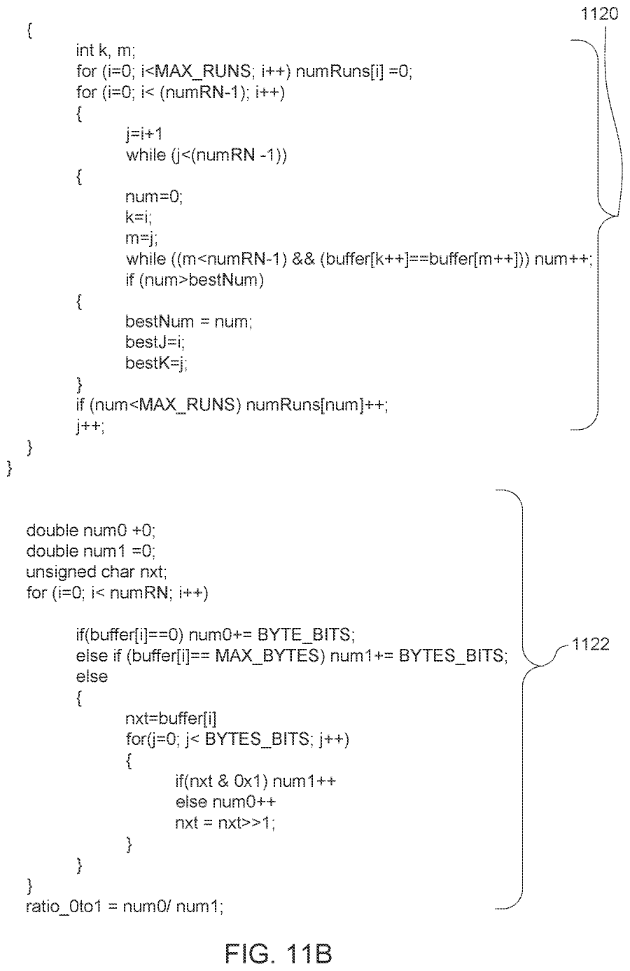

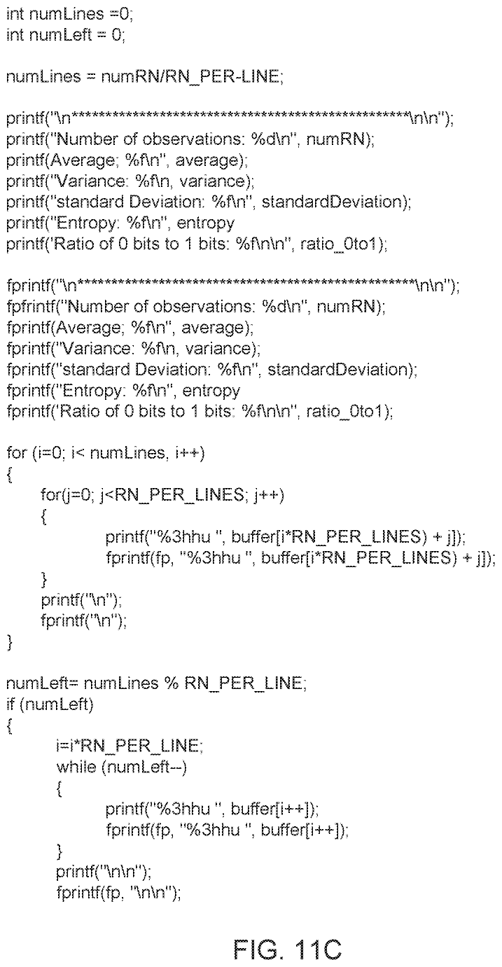

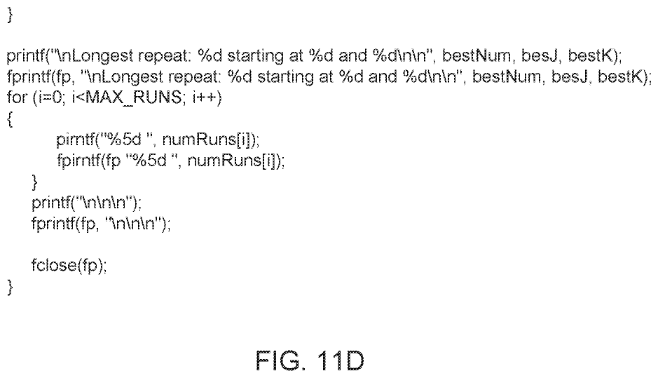

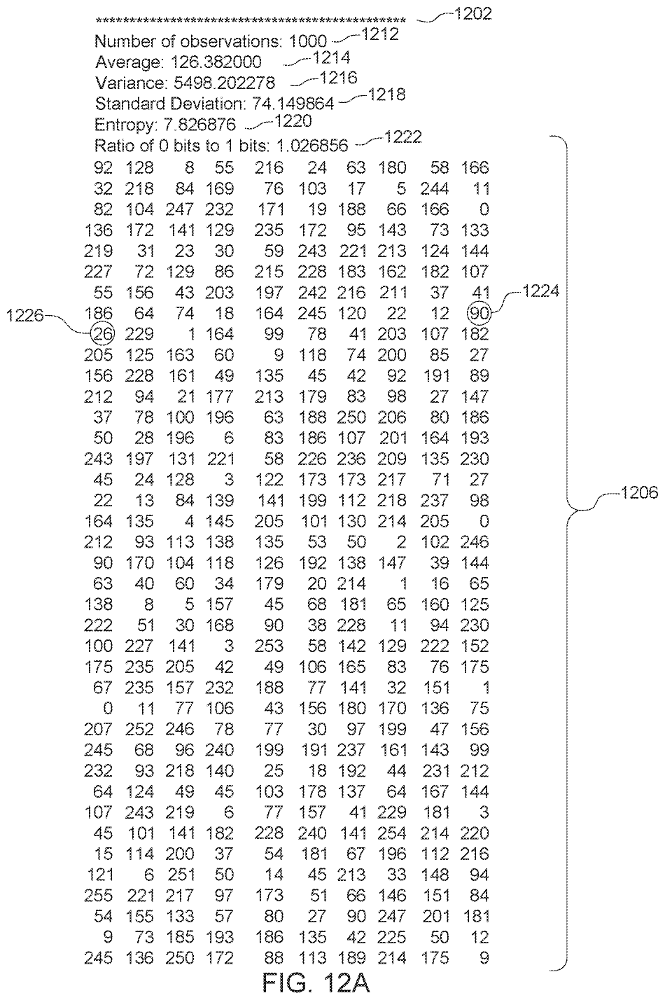

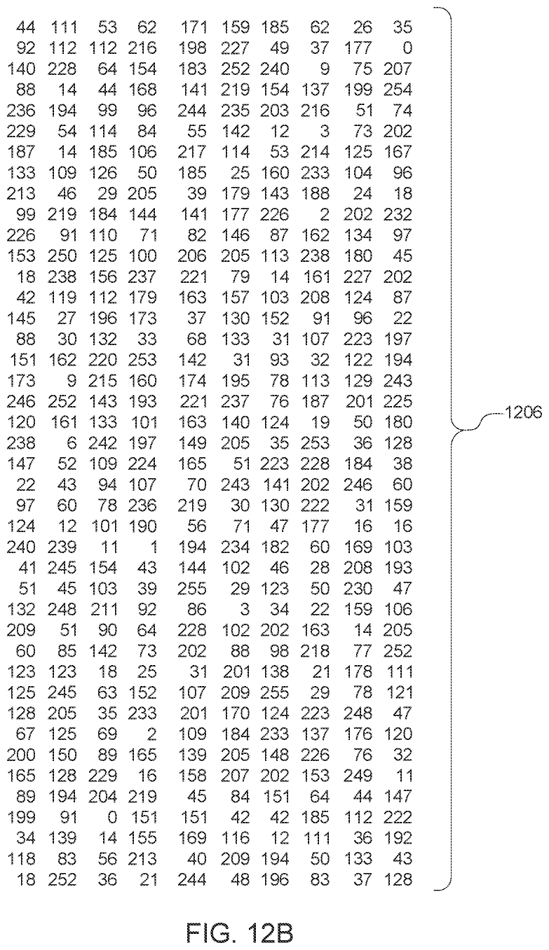

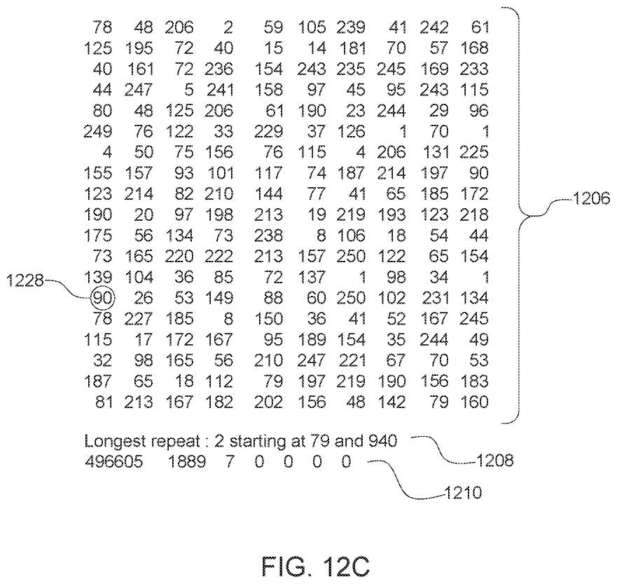

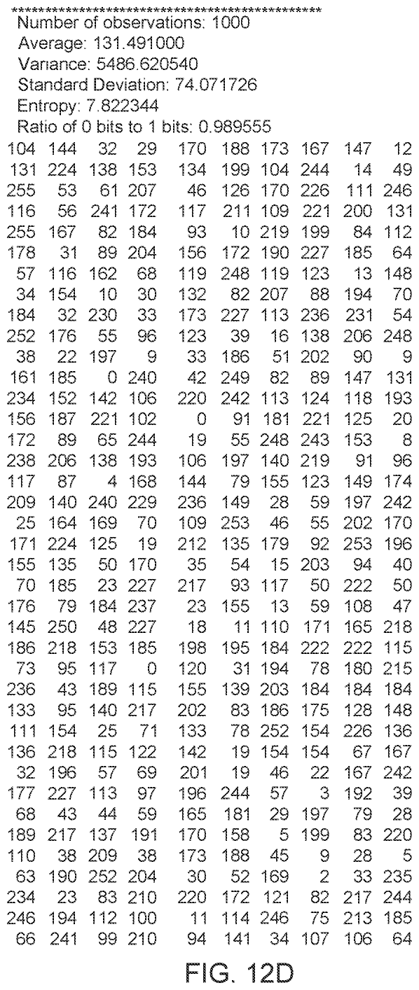

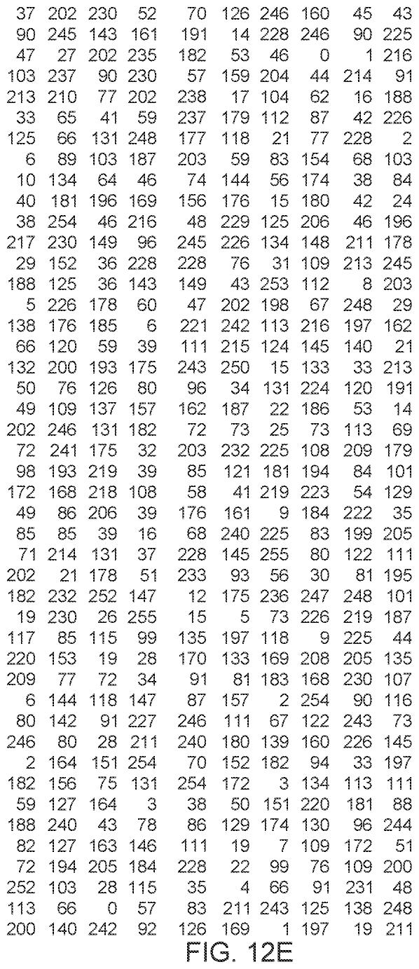

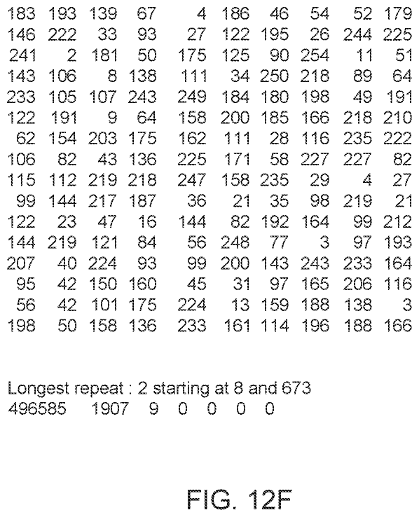

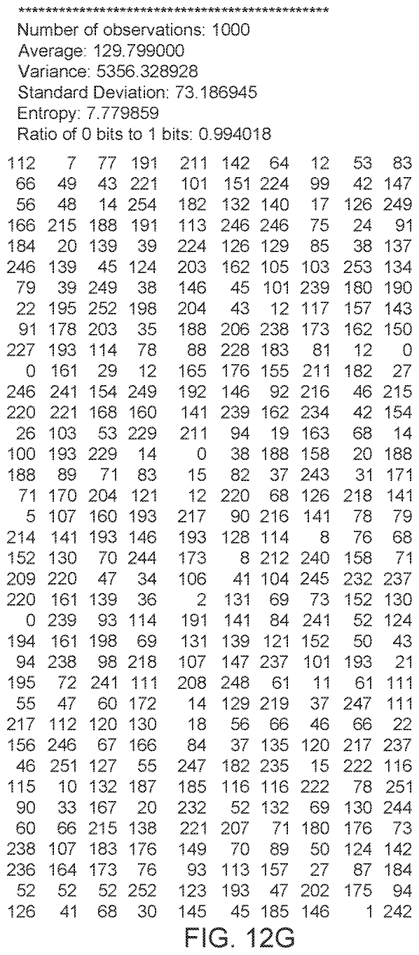

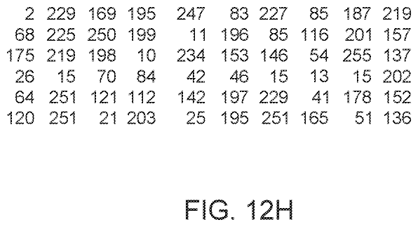

16) FIGS. 11A-D show an implementation of the rGenerator member function stats. 17) FIGS. 12A-H show three sequences of 1000 random numbers generated by the rGenerator member function generateRNs and printed out by the rGenerator member function stats.

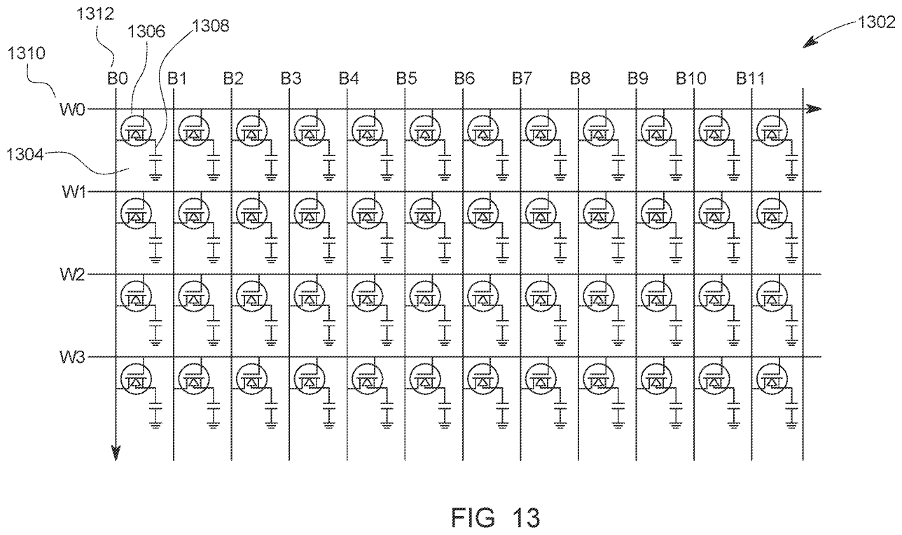

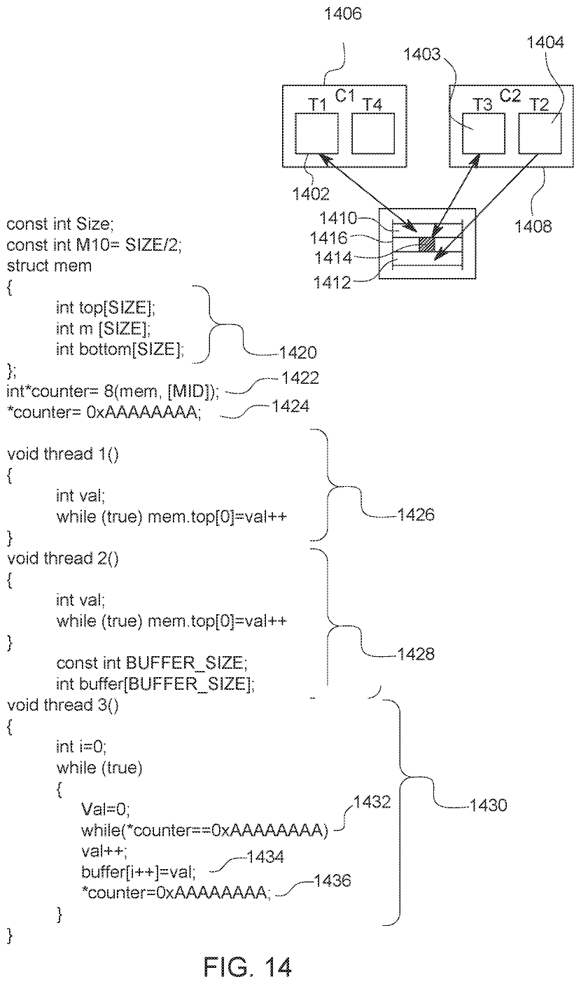

18) FIG. 13 shows the basic architecture of a dynamic random access memory (“DRAM”). 19) FIG. 14 illustrates a concept underlying a second implementation of the currently disclosed methods and systems based on bit-flipping of stored values in DRAMs, a phenomenon exploited in the Rowhammer attack.

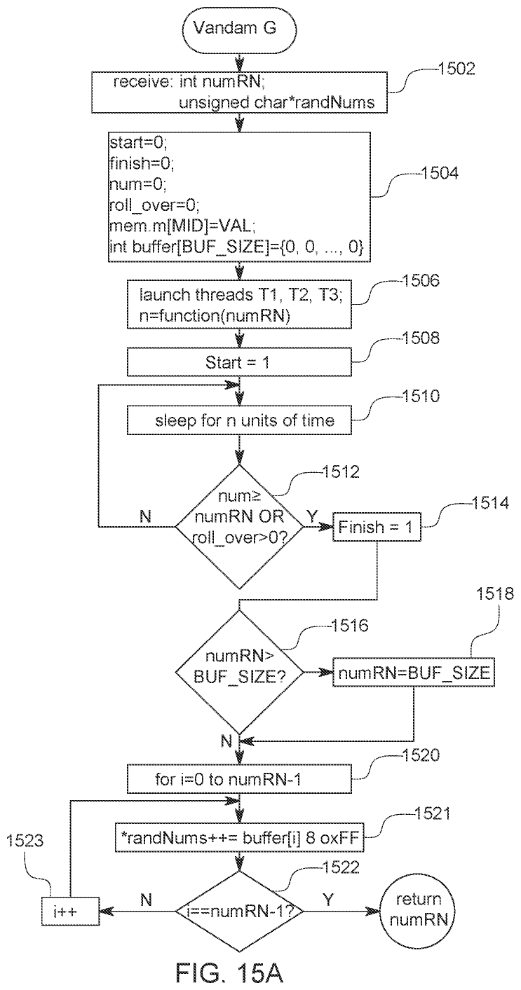

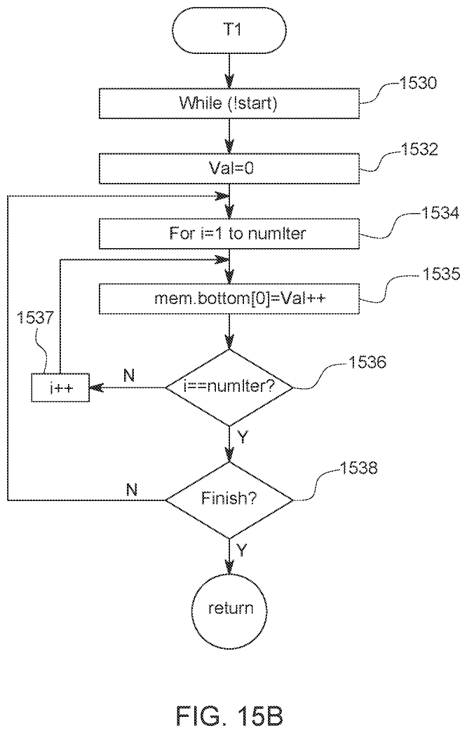

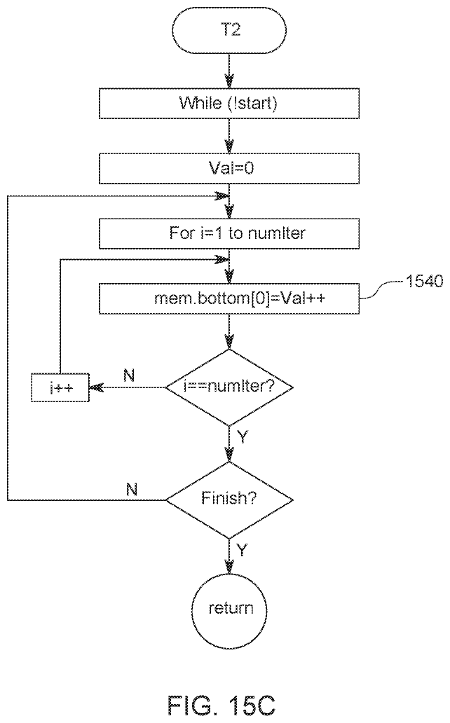

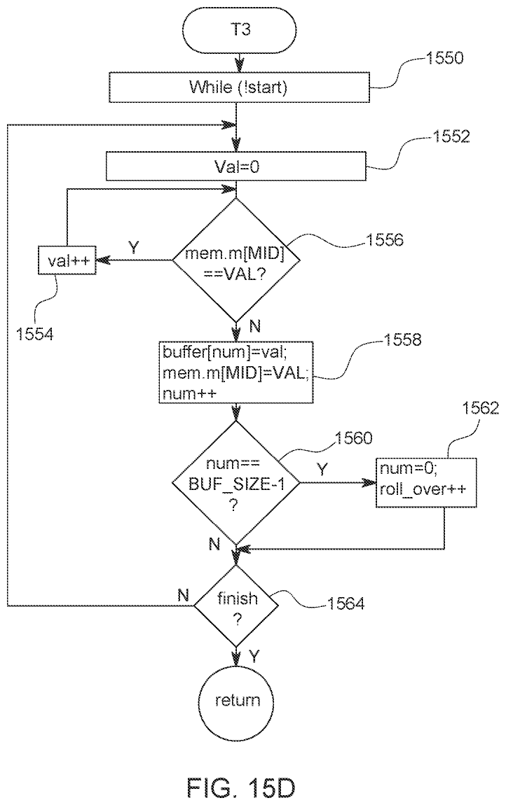

20) FIGS. 15A-D provide control-flow diagrams that illustrate a second implementation of the currently disclosed methods and systems for generating random numbers.

### DETAILED DESCRIPTION

21) The current document is directed to methods and systems that computationally generate sequences of random numbers based on underlying nondeterministic phenomena in computer systems. In a first subsection, below, a description of computer hardware, complex computational systems, and virtualization is provided with reference to FIGS. 1-5D. In a second subsection, the currently disclosed methods and systems are discussed with reference to FIGS. 6-15D.

### Computer Hardware, Complex Computational Systems, and Virtualization

22) The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

23) FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

24) Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

25) FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computer systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

26) Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

27) FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

28) Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

29) FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

30) While the execution environments provided by operating systems have proved to be an enormously successful level of abstraction within computer systems, the operating-system-provided level of abstraction is nonetheless associated with difficulties and challenges for developers and users of application programs and other higher-level computational entities.

One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

31) For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

32) The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

33) FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

34) While the traditional virtual-machine-based virtualization layers, described with reference to FIGS. 5A-B, have enjoyed widespread adoption and use in a variety of different environments, from personal computers to enormous distributed computer systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

35) FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

Currently Disclosed Methods and Subsystems 36 FIG. 6 illustrates the general problem domain addressed by the currently disclosed methods and systems. The currently disclosed methods and systems provide various different implementations of a random-number generator 602. The random number generator produces, on request, a sequence of n random numbers r₁, r₂, . . . , rₙ 604, where the rᵢ represent a random selection of n numeric samples from a random variable R 606. The random variable R is associated with a sample space, S. For currently discussed random-number generators, the sample space S is generally finite and the sampling is carried out with replacement, so that a given number may occur multiple times in a sequence of randomly selected samples. As indicated in FIG. 6 by expressions 608, example domains of a random variable R, or sample space S, include the nonnegative integers 610, the real numbers 611, the floating-point numbers available to a particular computational environment 612, or a subset of one of these domains, such as the integers within the range [a, b], where a and b are not negative integers. Even when the domain is not specified with a range, the sample space is generally finite, since the values are digitally represented, such as 64-bit integers, and digital representations generally imply a specific range of values. Furthermore, even when not digitally represented, generated real numbers are limited in precision. As indicated by expression 614 in FIG. 6, numeric values within a random-variable domain or sample space can have any of an essentially limitless number of different selection probability distributions, including a Gaussian or normal distribution, in which the probabilities of selection of the numeric values in the domain or sample space systematically vary, and a uniform distribution, in which the probability of selection of each numeric value in the domain or sample space is equal to every other. Sampling of a random variable for which the domain or sample space is uniformly distributed is random when the probability of selection of any particular numeric sequence is identical to the probability of selection of any other particular numeric sequence of equal length. Finally, as indicated by examples 616 in FIG. 6, there are many different possible tests that can be applied to the numeric sequences generated by a random-number generator to determine whether or not the numeric sequences appear to be the products of random sampling. Certain tests 618 for sample independence are related to the predictability of a next numeric value rᵢ₊₁ in a sequence of numeric values generated by the random-number generator given the knowledge of the numeric value rᵢ. Other tests 620, related to test 618, involve determining that there is a low probability of repeated patterns in sequences of numeric values generated by the random-number generator, with the probability steeply decreasing with increases in the length of the repeated patterns. Yet another test 622 is that the number of “1” and “0” bits in the digital representations of a sequence of numeric values generated by the random-number generator should be balanced, or equal. There are many additional tests, including comparing computed distributions of generated sequences of numeric values to well-known distributions characteristic of randomly sampled numeric values. However, ascertaining, at a quantitative level, a level of confidence that a particular random-number generator in fact generates numeric sequences representative of a random-selection process is generally difficult, if not impossible. 37) The current document illustrates several implementations of a random-number generator 630 that generates sequences of n numeric values 631, where n is specified in a request for numeric values that is input to the random-number generator. The sample space 632 is the nonnegative integers in the range [0, 255], each of which can be digitally represented by a single byte of 8 bits. It is desirable for the random-number generator 630 to produce sequences of numeric values that represent random sampling from a uniformly distributed random variable, although this is not a hard requirement provided that the generated numeric-value sequences can be processed, such as by inputting them to a cryptographic hash function, to generate numeric-value sequences that appear to be generated by sampling a uniformly distributed random variable 634. A number of different tests for randomness 636 are considered for the example implementations, including that the Shannon entropy approaches the value 8, as explained below, the absence of repeated patterns that would be highly improbable assuming that the sampling of each numeric value in the sequence is independent from the sampling of all other values in the sequence, and uniform distribution of “0” and “1” bits in the byte representations of the numeric values output by the random-number generator, with ellipsis 638 indicating additional tests and computed statistics and metrics. Of course, given the ability to generate random sequences of nonnegative integers in the range [0, 255], it is possible to use the sequences to generate random sequences of other types of numeric values corresponding to other random-variable domains. For example, given a computer architecture in which floating-point values are represented by 8 consecutive bytes, a generated sequence of 32 numeric values in the range [0, 255] can be used to generate a random sequence of 4 floating-point values simply by considering they properly aligned sequence of 32 bytes, in memory, to represent 4 floating-point values. Masking of certain bit fields can be used, in many cases, to restrict the random numbers to particular ranges.

38) FIGS. 7A-B illustrate Shannon entropy. Shannon entropy is a computed value related to the predictability of sequences of numbers or characters or, more generally, the information content of sequences of numbers or characters, and is frequently used in information sciences. The expression for computing Shannon entropy is closely related to the entropy computed in statistical mechanics and to the entropy of thermodynamics. As shown at the top of FIG. 7A, the Shannon entropy H_{Shannon} can be computed from the probability distribution P={p₁, p₂, . . . , pₙ} for sampling a sample space S={s₁, s₂, . . . , sₙ}, where pᵢ is the probability of randomly selecting sample si from the sample space S, according to the following expression:

$${H}_{Shannon} = {\sum }_{i = 1}^{n} {p}_{i} ( {log}_{2} ( {p}_{i} ) ) .$$

The larger the value of the Shannon entropy, the more information that may be contained in a numeric-value or character sequence produced by randomly sampling the sample space.

39) FIGS. 7A-B illustrates the computed Shannon entropies for six different probability distributions of random sampling from a sample space S containing the four different possible samples a, b, c, and d. Each of the six different computations based on the six different sampling probability distributions is illustrated by a histogram, such as histogram 702, the example sample space and associated sampling probability distribution, such as sample space 703 and sampling probability distribution 704, and the terms of the numeric computation of the Shannon entropy and the final computed Shannon entropy, such as expression 705. The sampling probability distribution P={1, 0, 0, 0} 704 for the sample space S indicates that every sample from sample space S will have the value a. Thus, there is essentially no information contained in a sequence of samples with this sampling probability distribution, since one knows, beforehand, that the only possible sequences contain only the values “a.” As one example, there would be no need to transmit a message to a remote observer to inform the remote observer of the outcome of a series of n samples, because the observer would know, beforehand, that the sampling will produce a sequence of n a samples. Furthermore, there is no unpredictability in sampling with this sampling probability distribution. It is completely non-random. Thus the Shannon entropy for this sampling probability distribution is 0.

40) The sampling probability distribution 706 indicates that three out of four samples will have the value a and one out of four samples will have the value b. Thus, there is some unpredictability in sampling from sample space S according to the sampling probability distribution 706 and a sequence of values such as “bbbbb,” by having a very low probability of being randomly selected, may contain a certain amount of information. However, the unpredictability associated with sampling, while much greater than for sampling probability distribution 704, is nonetheless rather low, since if one were to predict the next sample value to be a, one would have a ¾ probability of being correct. Thus, the Shannon entropy 708 computed from sampling probability distribution 706 is greater than 0, but still of relatively small magnitude.

41) The sampling probability distribution 710 indicates that one half of samples will have the value a and one half of samples will have the value b. Thus, there is more unpredictability in sampling from sample space S according to sampling probability distribution 710 than sampling from sample space S according to sampling probability distributions 704 and 706, since one cannot predict the next sample value to be a with greater probability than one can predict the next sample value to be b. Thus, the Shannon entropy 712 computed from sampling probability distribution 710 is greater than 0 and greater than the Shannon entropy 708 computed from sampling probability distribution 706.

42) Continuing to FIG. 7B, the sampling probability distribution 714 indicates that 40% of samples will have the value a, 40% of samples will have the value b, and 20% of samples will have value c. Thus, both the unpredictability in sampling according to sampling probability distribution 714 and the potential information content from sequences of sampled values is significantly greater than for the previously discussed probability sampling distributions, and this greater unpredictability and potential information content is reflected in the larger Shannon entropy 716 computed from sampling probability distribution 710. Similarly, the unpredictability and information content associated with sampling from the sample space according to the sampling probability distribution 718, which indicates that a sample may have any of the four possible values a, b, c, and d, is greater than the previously discussed examples, reflected in the even larger Shannon entropy 720 computed from sampling probability distribution 718.

43) Finally, for the sampling probability distribution 722, which indicates that a sample will return any one of the four possible sample values with equal probabilities, the computed Shannon entropy 724, 2.0, is greater than the Shannon entropies for all of the previously discussed sampling probability distributions. In fact, the Shannon entropy 2.0 is the highest possible Shannon entropy for sampling from sample space S. Thus, the Shannon entropy is an informative metric for evaluating the randomness of numeric sequences produced by a random-number generator. However, it is not, in fact, necessarily reflective of the randomness of sequence generation. For example, a random-number generator that always generates subsequences of the repeating sequence {a, a, a, b, b, b, c, c, c, d, d, d, a, a, a, b, b, b, . . . }, such as the subsequence {a, a, b, b, b, c, c, c, d, d, d, a, a, a, b, b}, would have a computed Shannon entropy of 2.0 when computed from one or more subsequences of generated values of lengths evenly divisible by 12. However, as soon as a pair of different values is identified in any subsequence, all remaining values in the subsequence are exactly predictable. In this case, the individual samples are not independent from one another. Thus, while entropy is one important metric, it does not, by itself, indicate random sampling and unpredictability of sampling.

44) FIG. 8 illustrates how the Shannon entropy is related to the number of questions, on average, needed to determine which value of a set of sample values has been generated by a random-number generator associated with the Shannon entropy. FIG. 8 uses the different sampling probability distributions discussed with reference to FIGS. 7A-B. A random-number generator 802 generates a next sample x 804. The problem is to determine how many questions, answered by either “yes” or “no,” an observer who has not seen x would need to ask the recipient of the next sample x in order to determine its value. For sampling probability distribution 704, no questions need to be asked 806 in order to determine the value of an unknown sample x generated by a random-number generator with the sampling probability distribution 704, since x can only have the value a. In the case that the random-number generator 802 is associated with the sampling probability distribution 706, one question is needed 808. As an example, the observer can first ask whether or not the value of x is a 810. If the answer is “yes,” then x has the value a. Otherwise, x has the value b. A similar result is associated with the sampling probability distribution 710, although, in this case, a and b are equally likely 711 while, in the previous case, a is more likely than b, and thus there is greater unpredictability in this case despite only one question needing to be asked. In the case that the random-number generator 802 is associated with the sampling probability distribution 714, the observer needs to ask either one or two questions 812. As an example, the observer can first ask whether or not the value of x is a 814. If the answer is “yes,” then x is a. Otherwise, the observer can next ask whether or not the value of x is b 816. If the answer is “yes,” x is b. Otherwise, x is c. For the remaining cases, two questions need to be asked, with the greatest unpredictability 818 associated with sampling probability distribution 722.

45) Consideration of the example shown in FIG. 8 leads to the conclusion that if the n samples of a sample space have equal probabilities of selection, and if n=2″, then the number of questions that need to be asked in order to determine the value of a sample with unknown value is x. This is also the Shannon entropy for the sampling probability distribution for the sampling space. In the case of a random-number generator that generates nonnegative integers in the range [0, 255], as discussed above with reference to FIG. 6, the Shannon entropy for a uniform sampling probability distribution containing 256 values is 8, where 28=256. Thus, the random-number generator should be associated with a Shannon entropy equal to, or reasonably close to, 8.

46) The currently disclosed implementations differ from one another, but have a set of common characteristics. First, each implementation computationally generates sequences of random numbers. Unlike the special-purpose features included in modern processors that allow for generation of sequences of random numbers based on measured or observed values of a special-purpose physical signal source, circuit, or device, the implementations of the currently disclosed methods and systems generate sequences of random numbers computationally, generally by launching several asynchronous threads or processes, and achieve random sampling using only the standard computational environment provided by modern generic computers. These standard computational environments include standard computational resources, including execution environments provided by operating systems and virtualization layers, memory and memory-based address spaces, and access to computational services provided by peripheral devices, including network-interface controllers, keyboards, mouses, and attached printers and mass-storage devices. The phrase “standard computational resources” is used, in this document, to refer to the standard computational resources, access to which are provided by operating systems and virtualization layers, provided by generic, standard computer systems and other processor-controlled systems and devices to facilitate execution of applications, as opposed to specialized, single-purpose circuits and devices, such as the specialized circuitry included in certain processors to provide access to a source of an unpredictable signal. Second, the implementations of the currently disclosed methods and systems generate sequences of apparently random numbers rather than sequences of pseudorandom numbers, as are generated by the various different currently available algorithmic pseudorandom number-generation methods. Third, there are many different sources of nondeterministic behavior that contribute to generation of random sequences of numbers by the implementations of the currently disclosed methods and systems. The random sampling is not based on a single source of entropy, such as a single noise circuit, failure of which can lead to nonrandom sampling that may be very difficult to detect. Thus, the implementations of the currently disclosed methods and systems are robust and not prone to failure due to the failure of a single component or signal source or due to incorrect assumptions about the independence of successive measurements or observations of a single component or signal source.

47) FIGS. 9A-C illustrates the concept underlying a first implementation of the currently disclosed random-number-generation methods and systems. FIG. 9A illustrates the approach of the first implementation of the currently disclosed methods and systems. This implementation is based on a simple, low-cost computer system with a two-core 902 and 904 processor. Four execution threads 906-909 are launched, and presumably execute in four different hardware threads, two threads per core. However, it is not strictly necessary that the threads execute truly simultaneously at the hardware level, provided that execution is scheduled fairly and in small-granularity time slices. All four threads share, and can access, an external global variable 910 stored in memory 912. The global variable most likely resides in a cache memory. In the example shown in FIGS. 9A-C, each thread executes a very simple routine 912 that increments the value stored in the counter two times. In an actual implementation, discussed below, the value in the counter is incremented millions of times by each thread. A pseudo-assembly-language version of the routine 914 is shown below the pseudo-C-language version of the thread routine 912. The assembly-language version of the thread routine includes eight different instructions, each labeled with a numeric label enclosed within a circle, such as the numeric label “0” 1916 for the first instruction. The instruction labeled “1” 1918 retrieves the value stored in the memory location corresponding to the counter variable into a register a. The instruction labeled “2” 1920 adds 1 to the contents of register a. The instruction labeled “3” 1922 stores the value contained in register a back to memory. The remaining instructions implement the for-loop in the C-language version of the thread routine 912.

48) There are many different aspects of a computer system that result in the actual sequence of instructions executed by the four different threads, in time, to be completely unpredictable. For one thing, in addition to these four threads, a modern computer system supports execution of many additional processes and threads associated with an operating system and other applications concurrently running within the computer system. Furthermore, operating-system threads and processes handle interrupts that are generated at unpredictable times by various different types of hardware events and software events that occur within the computer system. The amount of time taken to execute any particular instruction can vary dramatically, depending on current workload, states of various different hardware components and subcomponents, the data stored in registers, and even extremely low-level quantum effects associated with sub-microscale/nanoscale circuitry. There are literally millions of different sources of nondeterminism with respect to the temporal sequence of instructions executed by asynchronous threads in modern computer systems.

49) FIG. 9B indicates one possible temporal sequence of instruction execution for the four threads discussed above with reference to FIG. 9A. In this figure, it is assumed that no two instructions are executed exactly at the same time that the instructions can therefore be ordered sequentially in time. This assumption is made for ease of illustration. In fact, removing this assumption would generate even greater unpredictability with respect to the observed outcomes. There are four columns corresponding to the four different threads 920, 921, 922, and 923 in FIG. 9B. Each column includes the time-ordered sequence of instructions executed by the thread associated with the column, with the instructions indicated by the circled numeric labels shown in FIG. 9A for the pseudo-assembly-language version of the thread routine. Time flows downward, in the figure. Thus, the first instruction executed by the four threads is instruction “0” 924 executed by the first thread. The sequence of executed instructions can then be determined by moving downward in the figure. For example, the next executed instruction 926 is instruction “1” executed by the first thread and the third executed instruction 927 is instruction “0” executed by the second thread. The first thread sets its register a to O upon execution of instruction 926 since the counter variable is initialized to 0 by a process that launches the four threads. Similarly, the fourth and third threads set their register a to 0 by instruction executions 928 and 929. The third thread increments the value stored in its register a by instruction execution 930 and then stores this new value in the counter by instruction execution 931. Then, the second thread reads this value from the counter by instruction execution 932, updates the value by instruction execution 934, and then stores the new value in the counter by instruction execution 936. However, the first thread now stores the value in its register a into the counter, by instruction execution 937, which returns the value stored in the counter to 1. The sequence of instruction executions proceeds in a similar fashion to the final instruction execution 938 by the second thread, at which point all of the threads have completed execution of the thread routine (912 in FIG. 9A). The final value of the counter is 2, as a result of the final storage of the value into the counter by the second thread, by instruction execution 939.

50) FIG. 9C illustrates a second possible order of the instruction execution by the four threads, introduced in FIG. 9A. In this case, when all four threads complete, the value of the counter is 4, as a result of the last store of that value to the counter by the first thread 940. There are more than 25 million different possible sequences of instruction execution, and these different possible sequences of instruction execution can generate final counter values ranging from 2 to 8. The distribution of final counter values for the example of FIGS. 9A-C is not uniform, because, depending on the computational environment, certain counter values are generated from a larger number of the possible sequences of instruction execution than other counter values and because certain sequences of instruction execution are more probable than others, depending on various characteristics and parameters of the computer in which the four threads execute. However, under an assumption that the threads can be launched together within a very small time interval and that they do execute simultaneously, the final value of the counter is uncertain. In the actual implementation to be described next, the distribution of the byte values generated by the random-number generation is extremely flat and various metrics used to determine whether or not the generated sequences of random numbers represent results of random sampling from the sample space indicate that the random-number generator does produce sequences that represent a random sampling.

51) FIGS. 10A-B provide a first implementation of the currently disclosed methods and systems, introduced above with reference to FIGS. 9A-C. The C++ language is used for the first implementation. At the top of FIG. 10A, numerous libraries are included in a first set of include directives 1002. Next, a number of constants are declared 1004, including: (1) MAX_THREADS, a maximum number of threads that can be launched; (2) NUM_RANDOM_VALUES, the total number of possible values in the sample space; (3) MIN_NUM_RN, a minimum number of random numbers that can be requested, used in the implementation to avoid numerous error checks; (4) RN_PER_LINE, the number of lines of generated random numbers to print or write to a file; (5) MAX_RUNS, the maximum length of repeated-subsequences to check for; (6) L2, the base-10 logarithm of 2; (7) MAX_BYTE, the highest-value in the example space; and (8) BYTE_BITS, the number of bits per byte.

52) Two global variables 1006 are next declared. The global variable start 1007 is used to coordinate incrementing of the counter by the multiple threats. The global variable counter 1008 is the counter incremented by the threads (910 in FIG. 9A). A thread routine executed by the threads 1009 is then declared, an implementation of which is provided below. Finally, a class rGenerator 1010 is declared. An instance of the class rGenerator is a random-number generator that generates sequences of random numbers. The class rGenerator includes three public member functions: (1) generateNextRN 1011, which returns an unsigned character, or byte, representing a random sample from the sample space of nonnegative integers in the range [0, 255], with the argument numlter specifying the number of iterations of counter incrementing to be carried out by each thread and with the argument numThreads specifying the number of threads to launch; (2) generateRNs 1012, which generates a sequence of random numbers, with the argument numlterPerThread specifying a number of iterations of counter incrementing to be carried out by each thread, with the argument numThreads specifying the number of threads to launch, with the argument numRN specifying the number of random numbers to generate, and with the argument buffer referencing a memory buffer for containing the generated random numbers; and (3) stats 1013, which computes various statistics metrics for the random numbers in a memory buffer referenced by the argument buffer, with the argument numRN specifying the number of random numbers in the memory buffer.

53) FIG. 10B shows implementations of the thread function and the first two of the three member functions of the class rGenerator. The thread function 1020 continuously checks 1022 the external global variable start until it contains a value other than 0. Then, the thread function continuously increments the external global variable counter 1024 a number of times equal to the number of integration specified in the argument num_iterations. The rGenerator member function generateNextRN declares a local array of threads 1026, threads, and initializes 1028 the external global variable start to 0. Next, in the for-loop 1030, the member function generateNextRN launches a number of threads specified by the argument numThreads. Then, the member function generateNextRN sets 1032 the external global variable start to 1 and calls the thread function join 1034, for each launched thread, in order to suspend execution until all of the threads complete execution of the thread function. Finally, the member function generateNextRN extracts the low-order byte from the external global variable counter and returns that byte as the randomly sampled value from the sample space of nonnegative integers in the range [0, 255]. The rGenerator member function generateRNs first determines whether the argument numThreads has a value greater than the constant MAX_THREADS and, if so, sets numThreads to MAX_THREADS 1036. This represents a type of error checking that, in the current case, prevents division by 0 as well as generating meaningless statistics in the case that the rGenerator member function stats is subsequently called to provide statistics and metrics for the generated random numbers. There are many other points in the example implementation of the random-number generator in which additional error checking would be included, in a production implementation, but which are omitted for clarity of illustration in FIG. 10B. Then, in the for-loop 1038, the member function generateRNs calls the function member generateNextRN a number of times specified by the argument numRN to generate the requested number of random numbers and copy them into the memory buffer specified by the argument buffer.

54) The implementation shown in FIGS. 10A-B can be run on any modern personal computer and other processor-controlled devices to generate sequences of random numbers. By increasing the number of threads from 2 to larger values and by increasing the number of iterations per thread, slightly improved statistics and metrics for the generated random numbers can be obtained. In the output data shown below in FIGS. 12A-H, three threads were used, each of which iterated the for-loop 4,000,000 times.

55) FIGS. 11A-D show an implementation of the rGenerator member function stats. This member function is not described at the same degree of detail as the other member functions are described, above, but is included for completeness as well as to show an example of the computation of the various statistics and metrics. In a first for-loop 1102, the array estimatedPD is initialized to contain all 0 values. This array is used for a sampling probability distribution computed for the input sequence of random numbers. In a second for-loop 1104, the counts of the number of times each sample value occurs in the input sequence of random numbers are tabulated in the array estimatedPD and the total sum of the random numbers in the input sequence of random numbers is computed and stored in the local variable average. The local variable average is then divided by the number of random numbers in the input sequence of random numbers 1106 to generate the arithmetic average of the sequence of random numbers. In a third for-loop 1108, the tabulated accounts in the array estimatedPD are each divided by the number of random numbers in the input sequence of random numbers to generate estimates of the probability of observing each different sample value. In a fourth for-loop 1110, the sum of the squares of the differences between the random numbers in the input sequence of random numbers and the average value is computed and stored in the local variable variance, after which that value is divided by one less than the number of random numbers in the input sequence of random numbers 1112 to compute the variance. The standard deviation is then computed 1114 as the square root of the variance. In a fifth for-loop 1116 and by a following statement 1118, the Shannon entropy for the input sequence of random numbers is computed according to the expression for the Shannon entropy shown at the top of FIG. 7A and discussed above. In a next section of code 1120 that extends to FIG. 11B, the input sequence of random numbers is analyzed to find all possible repeated sequences, with the total number of repeated sequences with lengths of 0, 1, . . . , MAX_RUNS-1 stored in the arraynumRuns. A repeated run of length 0 indicates that there was no subsequent occurrence of a particular sample value following a currently considered sample value in the for-loop of the code section 1120. In a next code section 1122, the ratio of 0 bits to 1 bits in the digital representations of all of the random numbers in the input sequence of random numbers is computed and stored in the variable ratio_0 to1. The remaining portions of the rGenerator member function stats print the sequence of random numbers and the computed statistics and metrics to standard output as well as to a file.

56) FIGS. 12A-H show three sequences of 1000 random numbers generated by the rGenerator member function generateRNs and printed out by the rGenerator member function stats, both described above. Each output of a random-number sequence starts with a line of asterisks (e.g., 1202 in FIG. 12A), the set of statistics and metrics (e.g., 1204 in FIG. 12A), the generated random numbers, 10 per line (e.g., 1206 in FIGS. 12A-C), an indication of the longest repeating sequence in the input sequence of random numbers (e.g., 1208 in FIG. 12C), and the numbers of detected repeat sequences of lengths 0, 1, . . . , 6 (e.g., 1210 in FIG. 12C). In the first output, shown in FIGS. 12A-C, there are 1000 generated random numbers 1212. The average value of the generated random numbers 1214 is 126.38. The expected average value would be 126.5. The variance 1216 is 5498.2 and the standard deviation 1218 is 74.15, very close to values expected for a uniform sampling probability distribution for the sampling space of nonnegative integers in the range [0, 255]. The computed entropy 1220 is 7.83, close to the expected entropy of 8.0. The ratio of 0 bits to 1 bits (1222 in FIG. 12A) is 1.027, very close to the expected ratio of 1.0. The longest repeated subsequence detected in the 1000 random numbers has a length of 2, and only 7 of such repeating sequences were detected. The first such detected repeated sequence starts with the value 90 (1224 in FIG. 12A) and is followed by the value 26 (1226 in FIG. 12A), and begins with the 79th generated random number 1224 as well as with the 940th generated random number (1228 in FIG. 12B). The vast majority of the random numbers in the input sequence of random numbers were not followed anywhere in the remaining random numbers of the input sequence by another generated random number of the same value. Thus, all of the computed statistics and metrics would appear to be within a reasonable random fluctuation of their expected values. Note that the expected value of a random variable R is computed, for a discrete sampling probability distribution P(s) of the sampling space S, as:

$$E ( R ) = {\sum }_{s ∈ S} sP ( s )$$

and that the expected value for a function of R, g (R), is computed as:

$$E ( g ( R ) ) = {\sum }_{s ∈ S} g ( s ) P ( s ) .$$

The phrase “expected value” is, in statistics, well-defined and computable.

57) FIG. 13 shows the basic architecture of a dynamic random access memory (“DRAM”). The memory consists of multiple arrays of memory cells, a portion 1302 of one of which is shown in FIG. 13. Each memory cell, such as memory cell 1304, includes a metal-oxide-semiconductor field-effect transistor (“MOSFET”) 1306 and a capacitor 1308. The multiple arrays of memory cells are incorporated into an integrated circuit chip. Each capacitor can be in an uncharged or charged state, and these two different states are used to represent 1 and 0 bit values. Thus, each memory cell corresponds to a bit. The memory cells are arranged in a set of rows or word lines, such as the first word line 1310, that each represents a set of sequential bits in memory, and columns that each represent a bit position within a sequence of bits, such as the first column 1312. The DRAM includes various additional components, including multiplexers, word-line and column-line selectors, and latches. These additional components cooperate to write values to word lines and read values from word lines. The number of bits per word line is a parameter of a particular DRAM, but is often between 480 and several thousand. The DRAM reads and writes an entire word line in order to read or write one or more bits within the word line.

58) A particular type of security hack, referred to as the “Rowhammer” attack, was discovered for gaining access to privileged operating-system functionality. The Rowhammer attack involves repeatedly and rapidly accessing one or more word lines adjacent to a word line containing a memory word of interest. Due to the extremely small sizes of the memory cells and word lines, these accesses can result in instabilities in the value stored in the word of interest as a result of bit flips related to quantum-tunneling phenomena. This type of instability is a source of entropy that can be used to generate sequences of random numbers by various different implementations of the currently disclosed methods and systems.

59) FIG. 14 illustrates a concept underlying a second implementation of the currently disclosed methods and systems based on bit-flipping of stored values in DRAMs, a phenomenon exploited in the Rowhammer attack. FIG. 14 uses similar illustration conventions as those used in FIG. 9A. In this implementation, three threads 1402-1404 execute within two cores 1406 and 1408 of the processor within a computer system, such as a personal computer. The first thread 1402 repeatedly and rapidly accesses a first word line 1410 in a DRAM. The second thread 1404 repeatedly and rapidly accesses a second word line 1412 in the DRAM. A third thread 1403 monitors the value stored in a word or other unit of memory 1414 in a word line of the DRAM 1416 adjacent to the two word lines 1410 and 1412 that are repeatedly and rapidly accessed by the first and second threads. C-language pseudocode on the right-hand side of FIG. 14 illustrates the concept. The structure mem 1420 is mapped to three successive word lines in a DRAM. A first member of the structure mem, top, represents word line 1410. A second member of the structure mem, m, represents word line 1416. A third member of the structure mem, bottom, represents word line 1412. A reference to a word, or integer, within the word line corresponding to the member m of the structure mem, counter, is initialized 1422 and used to initialize the value stored in the word or integer referenced by counter 1424. The routine executed by the first thread 1426 rapidly and repeatedly accesses the word line represented by the member top of the structure mem. The routine executed by the second thread 1428 rapidly and repeatedly accesses the word line represented by the member bottom of the structure mem. The routine executed by the third thread 1430 continuously reads the value stored in the word or integer referenced by counter 1432. Each time the value stored in the word referenced by counter is accessed, a local variable val is incremented. When the value stored in the word referenced by counter changes from the initialized value, due to one or more bit flips, the routine executed by the third thread places the current value stored in local variable val into a next position within a buffer of values 1334 and resets the value stored in the word referenced by counter to the initial value 1336. This process continues indefinitely within while-loop 1338. Of course, as discussed below, in an actual implementation, the threads would terminate and the third thread would either terminate prior to filling the buffer with values or would wrap the index i back to 0 in order to avoid overwriting the buffer. Because the time at which a bit flip first occurs, following setting the word referenced by counter to a particular value, is non-deterministic, the set of values stored in the buffer by the third thread represent a source of random numbers.

60) FIGS. 15A-D provide control-flow diagrams that illustrate a second implementation of the currently disclosed methods and systems for generating random numbers. FIG. 15A provides a control-flow diagram for a routine randomG which generates a sequence of random numbers. The routine randomG receives an indication of the number of random numbers to generate, numRN and a reference to a buffer in which to store the random numbers, randNums, in step 1502. In step 1504, the routine randomG initializes four global variables start, finish, num, and roll_over to 0. In addition, the counter word (1414 in FIG. 14) within the global struct m is initialized to a value VAL and the contents of a global array buffer are initialized to 0. In step 1506, the three threads T1, T2, and T3 are launched and a local variable n is set to a value representing a time for the routine randomG to sleep before again checking to see if a sufficient number of random numbers have been generated by the three threads. To initialize local variable n, the routine randomG computes the sleep time as a function of the number of random numbers to generate. In step 1508, the global variables start is set to 1, to release the threads to begin generating random numbers. The routine randomG then sleeps for n units of time, in step 1510. Upon waking, the routine randomG determines, in step 1512, whether the value in global variable num is greater than or equal to the specified number of random numbers to generate, numRN, or whether the value in global variable roll_over is greater than 0. If either of the two parts of the Boolean expression is true, the global variable finished is set to 1, in step 1514, and control flows to step 1516. Otherwise, control flows back to step 1510 where the routine randomG again sleeps for n units of time. In step 1516, the routine randomG determines whether numRN is greater than the size of the memory buffer buffer. If so, then, in step 1518, numRN is set to the size of the memory buffer buffer, BUF_SIZE. Finally, in the for-loop of steps 1520-1523, a number numRN of random numbers is generated from the low-order bytes of the values stored in the global array buffer and stored in the buffer referenced by argument randNums.

61) FIG. 15B provides a control-flow diagram for the thread routine for thread T1. In step 1530, the thread routine spins until global variables start is set to a non-zero value. In step 1532, the thread routine sets a local variable val to 0. In the for-loop of steps 1534-1537, the thread routine continuously accesses the first word line represented by the member top of the struct mem. The for-loop iterates numIter times. Upon completion of the for-loop, the thread routine determines, in step 1538, whether or not the global variable finish has been set to a non-zero value. If so, the thread routine returns. Otherwise, control returns to step 1534 for a next iteration of the for-loop of steps 1534-1537.

62) FIG. 15C provides a control-flow diagram for the thread routine for thread T2. This routine is identical to the thread routine for thread T1 except that, in step 1540, the third word line represented by the member bottom of the struct mem is repeatedly accessed.

63) FIG. 15D provides a control-flow diagram for the thread routine for thread T3. In step 1550, the thread routine spins until global variables start is set to a non-zero value. In step 1552, the thread routine sets a local variable val to 0. Then, the thread routine repeatedly checks the counter word in the word line represented by member m of struct mem until the counter word has a value different from the value VAL, incrementing val each time the counter word is determined to have the value VAL, in step 1554. When a value different from the value VAL is detected in the counter word, in step 1556, the thread routine stores a current value of local variable val into a next element of the global array buffer, re-initializes member m of struct mem, and increments global variable num to indicate that another number has been placed into the global array buffer, in step 1558. When num contains a value equal to the index of the last element in the global array buffer, as detected in step 1560, num is set to 0 and roll_over is incremented, in step 1562. When global variable finish has a value other than 0, as determined in step 1564, the thread routine returns. Otherwise, control flows back to step 1552, to begin search for another value to store in global array buffer.

64) The present invention has been described in terms of particular embodiments, it is not intended that the invention be limited to these embodiments. Modifications within the spirit of the invention will be apparent to those skilled in the art. For example, any of many different implementations of the random-number-generation methods and systems can be obtained by varying various design and implementation parameters, including modular organization, control structures, data structures, hardware, operating system, and virtualization layers, and other such design and implementation parameters. For example, rather than counting iterations between bit-flip events, as in the above-described second implementation, a computed value may include a factor derived from the number of bits that have flipped in addition to elapsed time or number of iterations of checking the counter for one or more bit flips. Other types of computationally accessible sources of uncertainty can be alternatively used for random-number generation. The precise timing of events that depend on multiple internal steps or actions can be used, such as the time it takes to retrieve a value from memory or the time taken to receive an acknowledgement message in response to a transmitted message. As another example, rather than iterating for a particular number of iterations, threads can instead iterate for a particular amount of time. As yet another example, two threads, one of which repeatedly accesses an adjacent row to a counter, and the other of which checks for bit flips, can be used instead of the three threads used in the above-described second implementation. As yet another example, the random-number generator may write sequences of generated random numbers to memory buffer, output generated random numbers to a random-number output stream, or transmit generated random numbers to a random-number-consuming computational entity, such as an application. While execution threads running on hardware threads within multi-core processors are used in the described implementations, asynchronously execution processes that access a shared, standard computational resource or resources can be used in alternative implementations.

1. An improved random-number generator, implemented in a computer system or other processor-controlled device, that includes one or more processors, one or more memories, and computer instructions, stored in one or more of the one or more memories that, when executed by the one or more processors, control the computer system or other processor-controlled device to:
launch two or more asynchronous, concurrently executing processes or threads that repeatedly interact with a shared standard computational resource that exhibits, at a given point in time, one computationally accessible state of multiple possible states, the state of the shared standard computational resource changeable as a result of the interactions with the multiple asynchronous, concurrently executing processes or threads; and
generate, based on one or more determinations of the state of the standard computational resource at one or more points in time, a numeric random sample from a numeric sample space.

2. The improved random-number generator of claim 1
wherein the values of multiple statistics and/or metrics computed from each of multiple sequences of successive numeric random samples generated by the random-number generator of greater than a threshold length fall, for greater than a threshold number of the multiple sequences, within threshold ranges of the expected values for a sequence of randomly sampled numeric samples from the numeric sample space; and
wherein one or more tests for random sampling applied to each of multiple sequences of successive numeric random samples generated by the random-number generator of greater than a threshold length generate, for greater than a threshold number of the multiple sequences, results within threshold ranges of the expected results for a randomly sampled sequence of numeric samples.

3. The improved random-number generator of claim 2
wherein the statistics and metrics include entropy, average, variance, standard deviation, and ratio of 1 bits to 0 bits in the digital representations of the numeric samples in each sequence; and
wherein the tests include determining the number or repeated subsequences within each sequence.

4. The improved random-number generator of claim 1 wherein the two or more asynchronous, concurrently executing processes or threads each repeatedly increments a shared memory-based counter stored in one of the one or more memories.

5. The improved random-number generator of claim 4 wherein a portion of a current value stored in the counter is extracted as the numeric random sample from the numeric sample space.

6. The improved random-number generator of claim 5
wherein the extracted portion is a byte; and
wherein the sample space is the nonnegative integers in the range [0,255].

7. The improved random-number generator of claim of claim 5 wherein the random-number generator generates a sequence of random numbers of a specified length by:
iteratively,
launching two or more asynchronous, concurrently executing processes or threads, each of which repeatedly increments the counter; and
when the asynchronous, concurrently executing processes or threads finish executing, extracting a portion of the value stored in the counter and adding the extracted portion to the sequence of random numbers
until the sequence of random numbers has the specified length.

8. The improved random-number generator of claim of claim 1 wherein the two or more asynchronous, concurrently executing processes or threads include:
a first process or thread that repeatedly accesses a word line in DRAM memory adjacent to a word line that contains a unit of memory that stores a known value; and
a second process or thread that continuously monitors the unit of memory, while incrementing a local variable, to detect one or more bit flips within the unit of memory.

9. The improved random-number generator of claim of claim 8 wherein, when the second process or thread detects one or more bit flips within the unit of memory, the second process or thread writes the value in the local variable to a next available memory location in a memory buffer;
reinitializes the local variable; and
reinitializes the unit of memory to contain the known value.

10. The improved random-number generator of claim of claim 8 wherein the random-number generator generates a sequence of random numbers of a specified length by:
launching two or more asynchronous, concurrently executing processes or threads, a first thread or process of which repeatedly accesses a word line in DRAM memory adjacent to a word line that contains a unit of memory that stores a known value and a second of which continuously monitors the unit of memory, while incrementing a local variable, to detect one or more bit flips within the unit of memory;
when the second process or thread detects one or more bit flips within the unit of memory, the second process or thread
writes the value in the local variable as an entry to a next available memory location in a memory buffer,
reinitializes the local variable, and
reinitializes the unit of memory to contain the known value;
when the memory buffer contains a number of entries equal to or greater that the specified length,
extracting portions of the entries to generate the sequence of random numbers of the specified length.

11. The improved random-number generator of claim 10
wherein each extracted portion is a byte; and
wherein the sample space is the nonnegative integers in the range [0,255].

12. A method that generates a random number, the method comprising:
launching two or more asynchronous, concurrently executing processes or threads that repeatedly interact with a shared standard computational resource that exhibits, at a given point in time, one computationally accessible state of multiple possible states, the state of the shared standard computational resource changeable as a result of one or more of the interactions with the multiple asynchronous, concurrently executing processes or threads; and
generating, based on one or more determinations of the state of the standard computational resource at one or more points in time, a numeric random sample from a numeric sample space.

13. The method of claim 12 further comprising:
generating a sequence of numeric random samples, each numeric random sample based one or more determinations of the state of the standard computational resource at one or more points in time; and
verifying the sequence of generated numeric random samples of a particular length by:
computing the values of multiple statistics and/or metrics from the sequence of generated numeric random samples;
determining that the computed values fall within threshold ranges of the expected values for the multiple statistics and/or metrics for a sequence of randomly sampled numeric samples of from the numeric sample space;
applying one or more tests to the sequence of generated numeric random samples; and
determining that the one or more tests generate results within threshold ranges of the expected results for a randomly sampled sequence of numeric samples.

14. The method of claim 13
wherein the statistics and metrics include entropy, average, variance, standard deviation, and ratio of 1 bits to 0 bits in the digital representations of the numeric samples in each sequence; and
wherein the tests include determining the number or repeated subsequences within each sequence.

15. The method of claim 13 further comprising:
repeatedly incrementing a shared memory-based counter stored in one of the one or more memories by the two or more asynchronous, concurrently executing processes or threads; and
wherein a portion of the shared memory-based is extracted as the numeric random sample from the numeric sample space.

16. The method of claim 15 further comprising generating a sequence of random numbers by:
iteratively,
launching two or more asynchronous, concurrently executing processes or threads, each of which repeatedly increments the memory-based counter; and
when the two or more asynchronous, concurrently executing processes or threads finish executing, extracting a portion of the memory-based counter and adding the extracted portion to the sequence of random numbers
until the sequence of random numbers contains a specified number of random samples from the sample space.

17. The method of claim 13 wherein the two or more asynchronous, concurrently executing processes or threads include:
a first process or thread that repeatedly accesses a word line in DRAM memory adjacent to a word line that contains a unit of memory that stores a known value; and
a second process or thread that continuously monitors the unit of memory, while incrementing a local variable, to detect one or more bit flips within the unit of memory.

18. The method of claim 17 wherein, when the second process or thread detects one or more bit flips within the unit of memory, the second process or thread writes the value in the local variable to a next available memory location in a memory buffer;
reinitializes the local variable; and
reinitializes the unit of memory to contain the known value.

19. The method of claim 18 further comprising:
generating a sequence of random numbers of a specified length by
launching two or more asynchronous, concurrently executing processes or threads, a first thread or process of which repeatedly accesses a word line in DRAM memory adjacent to a word line that contains a unit of memory that stores a known value and a second of which continuously monitors the unit of memory, while incrementing a local variable, to detect one or more bit flips within the unit of memory;
when the second process or thread detects one or more bit flips within the unit of memory, the second process or thread
writes the value in the local variable as an entry to a next available memory location in a memory buffer,
reinitializes the local variable, and
reinitializes the unit of memory to contain the known value;
when the memory buffer contains a number of entries equal to or greater that the specified length,
extracting portions of the entries to generate the sequence of random numbers of the specified length.

20. A physical data-storage device that stores computer instructions that, when executed by one or more processors of a computer system or other processor-controlled device, control the computer system or processor controlled device to:
launch two or more asynchronous, concurrently executing processes or threads that repeatedly interact with a shared standard computational resource that exhibits, at a given point in time, one computationally accessible state of multiple possible states, the state of the shared standard computational resource changeable as a result of the interactions with the multiple asynchronous, concurrently executing processes or threads; and
generate, based one or more determinations of the state of the standard computational resource at one or more points in time, a numeric random sample from a numeric sample space.
